(19) United States
(12) Patent Application Publication
(10) Pub. No.: US 2024/0294004 A1
(43) Pub. Date: Sep. 5, 2024

(54) Double-Sided Thermal Ballot Stock

(71) Applicant: Parallel Wireless, Inc., Nashua, NH (US)

(72) Inventors: Brandon Kent, Sturgis, MI (US); Adam Meunier, Cumberland, RI (US); Michael Papa, Windham, NH (US)

(21) Appl. No.: 18/601,958

(22) Filed: Mar. 11, 2024

Related U.S. Application Data
(63) Continuation-in-part of application No. 17/818,260, filed on Aug. 8, 2022.

(51) Int. Cl. B32B 29/00; B32B 7/12; B32B 37/08; B32B 37/12; B32B 37/20; B32B 38/00

(52) U.S. Cl. CPC B32B 29/005; B32B 7/12; B32B 37/08; B32B 37/1207; B32B 37/20; B32B 38/1875; B32B 2037/1253; B32B 2255/12; B32B 2255/26; B32B 2255/28; B32B 2307/7375; B32B 2307/75; B32B 2309/02; B32B 2317/12

(57) ABSTRACT

A method of manufacturing double-sided thermally-printable ballot stock is disclosed, comprising: receiving a first and a second input roll of paper having a thermo-sensitive ink layer and a base paper layer and emitting a first web; tension evening of the first and second web using festooning rollers; applying an adhesive in a liquid state using anilox rollers to the base paper layer of the first web; laminating the first web and the second web through laminating rollers, with the base paper layer of the first web contacting the base paper layer of the second web using the adhesive to create a laminated output web; heating the laminated output web to cure the adhesive in an oven while moving the laminated output web through the oven; and reducing a temperature of the applied liquid adhesive in the laminated output web.

### CROSS-REFERENCE TO RELATED APPLICATIONS

This application is a continuation-in-part of, and claims priority under 35 U.S.C. § 120 to, U.S. patent application Ser. No. 17/818,260, filed Aug. 8, 2022, and having the title “Full-Face Ballot Printing Using Thermal Technology,” which is hereby incorporated by reference in its entirety for all purposes.

### BACKGROUND OF THE INVENTION

Paper, as typically formed and manufactured for use as an imaging medium, is typically formed by mechanically processing cellulose and/or other fibers into a flat surface or sheet by pulping, mechanical pressing to remove water, and heated drying. Paper may be manufactured in a roll to roll process, in which the continuous roll is referred to as a web as the paper moves by. Paper may be coated with material to create a surface more suitable for printing, and/or surfaced using a hard pressure roller called a calender or calendar, which may be heated or cooled as needed.

Thermal papers are papers that are configured to change color when energy, in the form of heat, is applied to the paper. The color change, which is a state change, is enabled using a surface coating of a solid-state mixture of a leuco dye, a developer acid, and a suitable matrix, an example of which is fluoran leuco dye. The leuco dye is present in a colorless form within the matrix. When sufficient energy is applied to the surface coating, the matrix melts, causing the dye to mix with the acid and in some cases a sensitizer, and change state to a non-colorless state. The changed form is then conserved in a metastable state when the matrix re-solidifies. A stabilizer may also be present to inhibit recrystallization of the dye and developer. Thermal papers may also include a protective top coating. Single-sided thermal papers are common, particularly for the use cases of gasoline pumps, cash registers, and other point of sale receipts.

Thermal printers are printers that apply energy to an imaging medium (e.g., paper) to cause a state change within or on the paper. By causing a state change on certain portions of the paper, an image is formed. Thermal printers are commonly used in applications such as small-format receipt printers.

In a different subject area, elections are a key area of societal interest that require efficient administration. Voters in many jurisdictions commonly indicate their selections on ballots by making marks on pre-printed ballots; however, it is expensive to print sufficient ballots to support the anticipated turnout for an election using prior art technologies. As well, in some jurisdictions voters are accustomed to using electronic voting devices to indicate their selections. These devices provide accessibility options for voters with disabilities and are intuitive for many voters, but the paper trail generated by such devices, typically in the form of a summary ballot, which is considered less auditable than traditional paper ballots. Accessible voting systems that have the auditability of hand-marked paper ballots are still an area of active interest.

### BRIEF DESCRIPTION OF THE DRAWINGS

FIG. 1A is an exterior diagram of a ballot marking system, in accordance with some embodiments.

FIG. 1B is a schematic diagram of a ballot marking system, in accordance with some embodiments.

FIG. 2 is a printer schematic design, in accordance with some embodiments.

FIG. 3 is a printer mechanism schematic design, in accordance with some embodiments.

FIGS. 4A, 4B, and 4C are alternative views of a paper axle hold down lock design, in accordance with some embodiments.

FIG. 4D is a perspective view of a paper roll brake design, in accordance with some embodiments.

FIG. 5 is a paper cross section schematic design, in accordance with some embodiments.

FIG. 6 is a schematic diagram of a method of manufacture for a double-sided thermal ballot stock, in accordance with some embodiments.

FIG. 7 is a further schematic diagram of a method of manufacture for a double-sided thermal ballot stock, in accordance with some embodiments.

### SUMMARY

While thermal printers are known in the art, the inventors have understood and appreciated the need for a double-sided thermal ballot stock.

In a first embodiment, a method is disclosed of manufacturing double-sided thermal ballot stock, comprising: receiving an input roll of paper having a thermo-sensitive ink layer and a base paper layer and emitting a first web; tension evening of the first web using festooning rollers; receiving a second input roll of paper having the thermo-sensitive ink layer and the base paper layer and emitting a second web; tension evening of the second web using the festooning rollers; applying an adhesive in a liquid state using anilox rollers to the base paper layer of the first web; laminating the first web and the second web through laminating rollers, with the base paper layer of the first web contacting the base paper layer of the second web using the adhesive to create a laminated output web; heating the laminated output web to cure the adhesive in an oven while moving the laminated output web through the oven; and reducing a temperature of the applied liquid adhesive in the laminated output web using an air cooling station.

The base paper layer comprises wood pulp. The adhesive applied between the two base paper layers may be acrylic. The temperature of the liquid adhesive may be below 100° F. at the time of application. The anilox rollers may be cooled to promote adhesion between the two base paper layers while preventing activation of the thermo-sensitive ink layer of the first web and the thermo-sensitive ink layer of the second web. One or more of the festooning rollers, the anilox rollers, the tensioning rollers, and the finishing rollers may be chrome rollers. The method may further comprise re-spooling an individual paper roll of the output web onto an additional roll core. The method may further comprise producing a roll core having an outer diameter greater than or equal to 4 inches, such that paper disposed on an inner diameter of the roll core may be conducive to printing flat output media. The method may further comprise producing a roll core having a core wall with a thickness greater than or equal to 0.5 inches to facilitate a printer paper brake. The method may further comprise cutting consumable rolls to a length of at least 200 feet long. The method may further comprise cutting consumable rolls to a length of at least 400 foot long and less than 525 feet long. The method may further comprise unspooling the output web from a larger roll and re-spooling the output web in the opposite direction to a smaller roll core to counteract a paper memory effect curl. The method may further comprise applying one or more of ultraviolet (UV) black light ink, infrared (IR) ink, thermochromic ink, holographic seals, watermarks, and preprinted barcodes for election security. The method may further comprise applying a top coat for hand-markability.

In a second embodiment, a double-sided thermally-printable paper is disclosed, comprising: a first top coating layer having an outer side and an inner side; a first thermal color change chemistry layer having an outer side and an inner side, the outer side bound to the inner side of the first coating layer; a first primer layer having an outer side and an inner side, the outer side bound to the inner side of the first thermal color change chemistry layer; a first base paper layer having an outer side and an inner side, the outer side bound to the inner side of the first primer layer; an interpositional adhesive layer having a first side and a second side, the first side bound to the inner side of the first base paper layer, a second base paper layer having an inner side and an outer side, the inner side bound to the second side of the interpositional adhesive layer; a second primer layer having an inner side and an outer side, the inner side bound to the outer side of the second base paper layer; a second thermal color change chemistry layer having an inner side and an outer side, the inner side bound to the outer side of the second primer layer; and a second top coating layer having an outer side and an inner side, the inner side bound to the outer side of the second thermal color change chemistry layer, the first thermal color change chemistry layer and the second thermal color change chemistry layer being thereby disposed to be printed on from either side of the double-sided thermally-printed paper.

The inner side of the first base paper layer may further comprise a first protective back coating layer and the inner side of the second base paper layer may further comprise a second protective back coating layer, the first and the second protective back coating layer for preventing migration of adhesive from the interpositional adhesive layer. The first thermal color change chemistry layer and the second thermal color change chemistry layer may each have a thermal response with a dynamic sensitivity of at least 1.8 ODU at 14 mJ/mm² and an optical density greater than 1.10 optical density units (ODU). The interpositional adhesive layer may be cooled during manufacture to reduce the likelihood of thermal color change of the first thermal color change chemistry layer and the second thermal color change chemistry layer. The interpositional adhesive layer may be cooled using an air cooling station during manufacture. The interpositional adhesive layer may be cooled using a plurality of chilled rollers during manufacture. The first thermal color change chemistry layer and the second thermal color change chemistry layer may each use a lueco dye thermal color change chemistry. The method may further comprise a roll core, and the double-sided thermally-printable paper may be rolled around the roll core. An inner diameter of the roll core may be 3 inches and an outer diameter of the roll core may be 4 inches. The paper may have a width of 8½ inches. The first top coating layer and the second top coating layer may be formulated to be free of bisphenol-A (BPA). The paper may have a lay flat curl characteristic when cut to standard United States legal size. The paper may further comprise one or more of ultraviolet (UV) black light ink, infrared (IR) ink, thermochromic ink, holographic seals, watermarks, and preprinted barcodes for election security. The paper may further comprise a top coat for hand-markability. The paper may be used for election ballots.

### DETAILED DESCRIPTION

The inventors have determined that there is a need for double-sided thermally-printed full-face ballots, and have developed a voting system for use therewith. A ballot marking system with an included printer module is described, in accordance with some embodiments. Marked ballots representing a voter's vote selections are enabled to be printed, in some embodiments. On-demand printing of unmarked ballots can also be achieved to support voting by hand-marked ballot. The use of full-face ballots provides a valuable safeguard and audit trail for voting. Hand-marked or machine-marked ballots are both used in election administration, and both are facilitated using the ballot printing machine described herein. A ballot marking system incorporating a double-sided thermal printer, as well as paper handling mechanisms and appropriate paper relevant thereto, are herein disclosed and described.

It is notable that the requirements for ballot printing exceed receipt printing: Consistency across the page (more a function of the paper and its layer of thermal reactive coating) is important, as optical scanners are typically used for tabulating ballots. The use of machine-marked printed ballots greatly enhances machine readability, in some embodiments. Hand-marked and machine-marked ballots are both supported, in some embodiments. The use of ballots as described herein are contemplated for both central count or hand-feed optical scanners. However, ballots are ideally both machine-readable and human-verifiable. Full-face ballots are more human-verifiable than summary ballots because voter intent is expressed in a human-readable format that is also tabulated by the tabulation software, whereas it is common in summary ballots for a machine to tabulate machine-readable representations of the voter intent such as barcodes or QR codes, which are less human-verifiable. In addition, full-face ballots that are both printable and human-markable offer the advantage of being suitable for use with or without the use of a ballot marking device (BMD), which allows for resilient use in case of a loss of electrical power.

Direct thermal printing also offers many advantages compared to other printing technologies, including greater durability, fewer moving parts, no ink, toner, or ribbon consumables. Additionally, the ability to print both sides simultaneously and with minimal “warm-up” time provides a significant increase in the speed of printing. Printing from a paper roll also supports printing a range of ballot lengths, as detailed below, without the need to load paper of the appropriate size in the printer. Paper ballots are generally subject to record retention requirements even after the votes have been tabulated. The drawbacks of thermal printing are generally focused around the durability of the resulting print, as heat and light can cause the image to degrade. However, the inventors have identified that it is advantageous to use thermal paper that meets or exceeds such record retention requirements, provided that the pre- and/or post-imaging ballots are stored in a temperate, indoor controlled environment in accordance with the paper's specifications. The specialized paper required for thermal printing is itself a security measure, ensuring that counterfeit ballots are more easily spotted and that election security can be maintained by requiring the special paper. As well, much less energy is used than with laser printing, which is a desirable characteristic especially when battery backup capability is desired.

As used herein, the following terms shall have the following meanings. The terms “double-sided full-face thermal ballot printer,” “full-face thermal ballot printer,” “thermal ballot printer,” and permutations thereof shall be understood to have substantially the same meaning as one another. The term “ballot marking system” is understood to refer to an AIO computer module and thermal printer as described substantially herein, mounted in a case, preferably an ATA case, optionally provided together with additional components as described herein. The term “embedded printer” is understood to refer to a printer component without the enclosure. The term “printer module” is understood to refer to a thermal printer in its enclosure. The term “enclosure” is understood to refer to an exterior of the printer assembly. The term “setup case” is understood to refer to an ATA (Air Transport Association) case or other durable case in which an AIO computer module and printer are mounted, and the terms “setup case lid” and “setup case body” are understood to refer to the top and bottom portion of a setup case. The term “All-in-One (AIO) computer module” is understood to refer to a computer module of the voting system, which may include one or more of: a touchscreen interface; a touchscreen; a CPU; a battery; and other accessibility provisions. The term “full-face ballot” is understood to refer to a printed ballot from a ballot marking system that has the same content and layout as a preprinted ballot for hand-marked voting, including non-selected choices, in contrast to a summary ballot, which only lists the choices selected by the voter. The term “jurisdiction” is understood to refer to a locality that administers elections, which may include multiple precincts or election districts having the same requirements. The term “ballot marking or printing application” is understood to refer to software that produces the output of a marked or unmarked ballot to be printed. In addition, where required for consistency or context, the terms in this paragraph may also retain their commonly understood meanings.

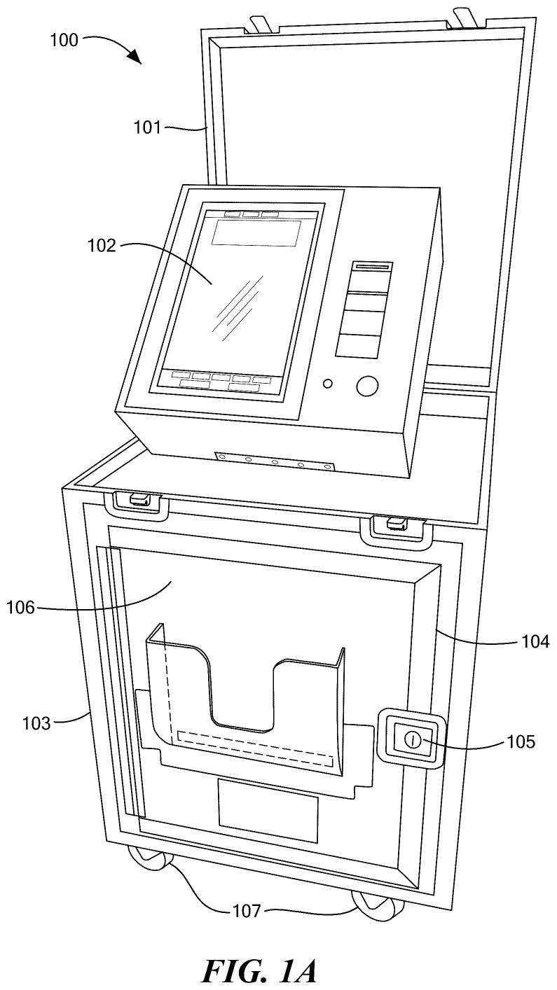

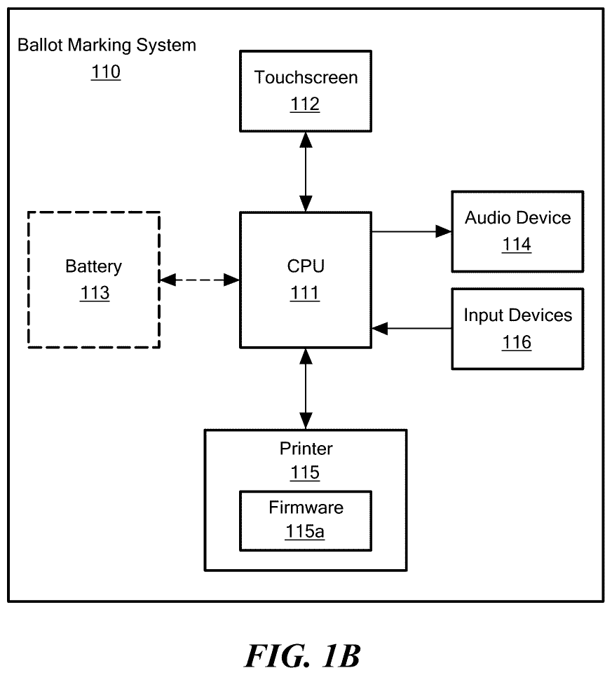

FIG. 1A is an exterior diagram of a ballot marking system, in accordance with some embodiments. Ballot marking system 100 is configured to be operated by an individual voter. A setup case is designed so that the ballot marking system can be operated by voters in either a standing or sitting position. The setup case lid 101 can be closed to protect the AIO voting system during transport and opened during operation. An AIO computer module 102 is equipped with software that presents voting options to an individual voter so that he or she can indicate his or her vote selections. AIO computer module 102 is on hinges or rails, in some embodiments, such that when setup case lid 101 is closed it is folded flat in a protected orientation, but when setup case lid 101 is opened it is configured in a vertical orientation for operation by the individual voter. AIO computer module 102 is optionally position-adjustable.

One or both of AIO computer module 102 and lid 101 are mounted to setup case body 103, in some embodiments. One or more rear hinges (not shown) connects setup case lid 101 and setup case body 103. Setup case lid 101 and setup case body 103 are made of a durable material such as a strong plastic or wood, or other material having favorable structural characteristics, with metal, or other robust material, hardware for protecting any areas that come into regular and/or heavy contact with one other or external forces, such as interfaces between setup case lid 101 and setup case body 103, or edges of the case material in order to preserve structural rigidity and integrity.

Setup case body 103 may have a top surface to which AIO computer module 102 is mounted. Setup case body 103 may be substantially hollow and may enclose a printer module, which is accessible by opening access door 104. Access door 104 includes locking mechanism 105, which may be any locking mechanism known in the art such as a butterfly turn latch. Locking mechanism 105 may be secured with a padlock or other secure locking mechanism for safety and security of election administration, including the application of tamper-evident seals. Access door 104 also includes slot 106, which is aligned with the printer module such that it enables the printer module to emit a sheet of paper to the individual voter. In some embodiments, slot 106 may be configured to emit paper in an upward direction toward the voter. In some embodiments, slot 106 may be configured to emit paper in a horizontal direction toward the voter. Setup case body 103 may also have attached wheels 107 to enable election administrators to move the ballot marking system within, into, or out of a voting area. Configurations of the ballot marking system may be configured to meet the accessibility and usability guidelines of, e.g., the Americans with Disabilities Act (ADA) or the U.S. Election Assistance Commission (EAC) Voluntary Voting System Guidelines (VVSG), and various additional physical configurations of setup case lid 101 and setup case body 103 are also enabled in certain embodiments, such as configurations with a lower height, with a printer in a different location, and/or with a recessed volume directly in front of the ballot marking system so as to enable a wheelchair operator to comfortably operate the ballot marking system while seated directly in front of the machine.

FIG. 1B is a schematic diagram of a ballot marking system, in accordance with some embodiments. Ballot marking system 110 is controlled by CPU 111, which is in communication with touchscreen 112, optional battery 113, audio device 114, printer 115 (with firmware 115a). Additional input devices, shown as 116, can be used for accessible operation of the ballot marking system, such as keypads, rocker paddles, or sip-and-puff devices, in some embodiments. The CPU 111 may be any appropriate CPU, such as an ARM processor on a system-on-module (SOM) with internal flash storage, and may also be disposed on a logic board with additional features and functions, such as a USB controller, etc., in some embodiments. The touchscreen 112 may be sized to comfortably allow a user to operate during election administration, preferably between 10″ and 16″.

Battery 113 is optional, in some embodiments, but it is desirable to have a battery that is able to provide backup for mission-critical elections administration. In an elections context, battery backup is often a requirement of the industry. Laser printers use a great deal of power; thermal printing is desirable as it is more efficient and consistent in terms of its energy consumption. Two hours or more of battery backup operation is enabled assuming a moderate duty cycle, in some embodiments. In some embodiments, ballot marking system 110 and printer 115 may operate on mains power with battery backup; in other embodiments, ballot marking system 110 and printer 115 may operate with battery power as its primary power source. CPU 111 may have at least the ability to monitor battery level, in some embodiments.

Audio device 114 may be a speaker, a headphone jack, or both, and may provide assistive features in compliance with the ADA or VVSG as well as providing audible alerts. Touchscreen 114 and additional input devices 116 may also provide assistive features. The printer is described further herein and receives ballot images from the CPU to be printed via the firmware 115a. Firmware 115a may be modified using CPU 111.

In operation, a voting administrator may move the ballot marking system 100 to its desired position in the polling location, unlock and open the setup case, configure the system via the touchscreen or other assistive input devices, plug in an electrical plug for operation on mains power (the battery, if installed, is understood to be used primarily for power failures), and perform any preliminary procedures before voting commences. An individual voter operates the ballot marking system to indicate their vote selections, receives a printed ballot from slot 106 with his or her vote choices filled in, and inserts the printed ballot into a ballot scanner to finish voting.

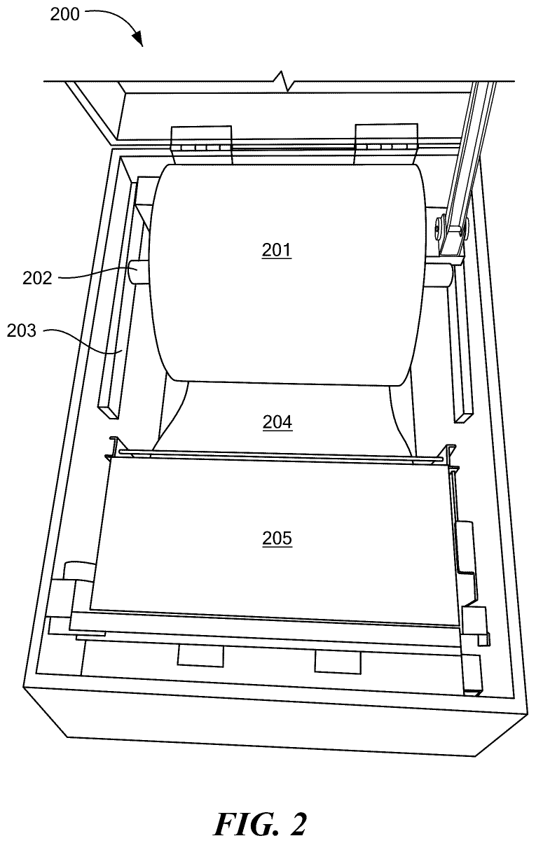

FIG. 2 is a printer diagram top view into enclosure, in accordance with some embodiments. Top-down view 200 shows paper roll 201 mounted on shaft 202, which is coaxially mounted with locking mechanism 203. Paper 204 is a portion of paper roll 201 that hangs off of the paper roll and is fed into printer module 205. A motorized synchronized friction drive is used for feeding paper between the dual print heads, with rubber or other high-friction rollers being used to grip the paper and feed it into printer module 205. In some embodiments, two or more synchronized rollers, including one on each edge of the paper, are used to feed the paper. In other embodiments, a pair of drum rollers is used to feed the paper. Roller speed is controlled by the printer software and/or firmware, in some embodiments. A paper roll with an 8.5″ width is enabled to be used, with an outer diameter of up to 8″, in some embodiments. The shaft 102 is configured to support a paper roll of at least 11.5 pounds.

A cutter is incorporated into embedded printer 205, in some embodiments, and may be configured in software to cut the completed ballots into any desired size. This is desirable as different regions or voting jurisdictions may have different requirements or preferences concerning the size of paper to be used, and additionally the use of specially sized paper may be advantageous for election security, such that the use of a roll of paper combined with a cutter enables a single ballot marking system to be used for multiple different elections with different requirements.

In an alternate embodiment, individual sized sheets of paper may be supported, using a paper tray and paper feed mechanism and configured to feed individual sheets into the printer module 205. In an alternate embodiment, the printer module may be configured separately from an all-in-one voting device, for example, in a printer-only configuration to enable election administrators to preprint ballots for use on a day of an election.

In some embodiments, the printer may be encapsulated in a metal enclosure to prevent tampering, thus forming a printer module, in some embodiments. The printer module may be secured to the setup case using rails, screws, or other structural components, in some embodiments. The printer module may be physically configured within the ballot marking system such that printed sheets emerge from slot 106 at the front of the setup case, in some embodiments.

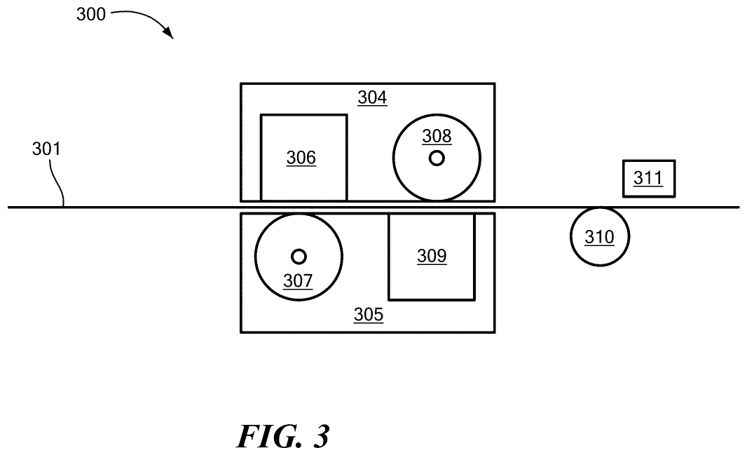

FIG. 3 is an embedded printer mechanism schematic design, in accordance with some embodiments. Printer mechanism 300 is shown in cross-section and in schematic fashion and does not include an enclosure or any structural portions of the design. Paper is fed through paper path 301 through the mechanism between print head module 304 and print head module 305. Within the print head modules, two print heads 306, 309 are used, one on each side of the paper. Print head 306 is aligned with platen 307, and print head 309 is aligned with platen 308. Platen 307 and platen 308 also provide the function of friction rollers, advancing paper through the printer. Paper is printed and passes over roller 310 and is fed under cutter 311, which cuts the paper into sheets.

The print heads are the width of the paper, in some embodiments, and transfer thermal energy to the paper as it passes through the paper path. The platens are positioned on the reverse side of the paper from their respective print heads. The platens hold the paper in contact with the print heads to facilitate energy transfer, and are made of a sufficiently dense and thermally non-reactive material such that they do not heat the reverse side of the paper to produce an image.

The printer may be configured with thermal sensors, in some embodiments, and the system may also be configured to prevent printing when the internal assembly exceeds a certain temperature, or indirectly by limiting the number of pages that can be printed in a minute.

Firmware may be used to control temperature of the print head, in some embodiments. Notable is that the darkness of an image is proportionally related to the amount of power used to heat the print head. Increasing the density increases the amount of power the print heads produce, such that the more density, the more it heats up, resulting in a darker image. Greater temperature of the print head thus increases the power draw. In some embodiments, software is used to enable an operator to configure the firmware to change printer density such that the printer produces an image that is acceptable but does not draw too much power. In some embodiments, acceptable image darkness may be configured based on regulations for a specific voting jurisdiction.

It is also notable that based on the temperature of the print heads, the paper may experience increased friction, and this change in paper velocity may affect dual side image registration. In some embodiments, firmware may be used to enable the configuration of the desired print head temperature. In some embodiments, the thermal characteristics of the paper are matched to the thermal characteristics of the print head. Print speed, energy draw, and print head temperature are correlated to produce a successful printed ballot while meeting desirable imaging and energy requirements, in some embodiments.

Printing shall be enabled on substantially all of the face of the paper, less reasonable or required margins, in some embodiments. In some embodiments, printing is enabled as close as 2.5 mm to each edge of the paper in the direction perpendicular to the paper path. This characteristic of the system is important, as the tabulation process typically depends on the presence of printed timing marks around the edge of the ballot.

The large format direct thermal printing paper has a thermal print coating on both sides, in some embodiments, and is provided in a roll of greater than 8″ in width, in some embodiments. The roll is sized to be loaded as a consumable into a portable ballot printing device including a cutter. A variety of roll widths may be supported, in some embodiments, such as 7, 8, 8.5, 9, 10, and 11 inches wide. The preferred width is 8.5 inches wide. Common supported lengths are 11″, 14″, 17″ but can also be as short as 8″ or 30″ or longer, in some embodiments.

Alignment roller 310 at the end of the paper path allows the printed sheet to emerge from the print path in proper alignment to be cut by cutter 311. Cutter 311 may use a blade drawn across the paper horizontally, perpendicular to the direction of travel of the paper, synchronized to the time the paper exits along the paper path, in some embodiments. The blade may be drawn across the paper path using motorized gears (not shown) on the side of the printer paper path. Cutter 311 may be configured to operate with a paper width of 8.5″, in a preferred embodiment. In some embodiments, the cutter may be provided with the printer module. In some embodiments, the printer may be configured in firmware, software, or both to output sheets of a specified size by cutting the continuous roll of paper. In some embodiments, sheets of US Letter size, US Legal size, or another size may be configured. In some embodiments, software may be configured to allow an operator to select one of a variety of sizes, or may be configured to allow the operator to select a size that corresponds to a number of voting options.

A roll of thermal paper is mounted into the printer and is configured to feed paper into the printer mechanism shown in FIG. 3. The roll of thermal paper is quite heavy and it is desirable for the roll to be secured during transport while remaining in the printer to avoid unspooling or crumpling of the paper in transit.

The printer is configured within an enclosure, the enclosure being also configured to hold within it a roll of paper in alignment with a feeding mechanism of the printer using an axial roll holder mounted on two inner sides of the mounting box. In some embodiments, a paper roll locking mechanism may also be provided. In some embodiments, the paper roll locking mechanism may have a manual knob for operation disposed outside of the mounting box. In some embodiments, the manual knob may be physically coupled to the locking mechanism within the box such that turning the manual knob allows an operator to lock or unlock the paper roll locking mechanism. Entry to the enclosure may be secured with a keyed entry lock. The enclosure may in turn be mounted to the interior of a ballot marking system setup case, in some embodiments using screws that mount to pull-out rails, in some embodiments disposed towards the bottom of the setup case. In some embodiments the enclosure material may be steel or aluminum. In some embodiments, another material that is not metal may be used.

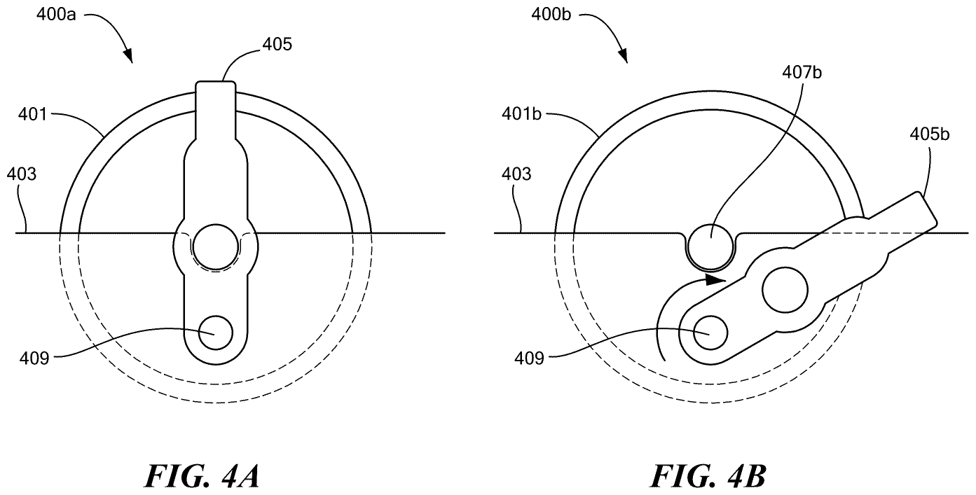

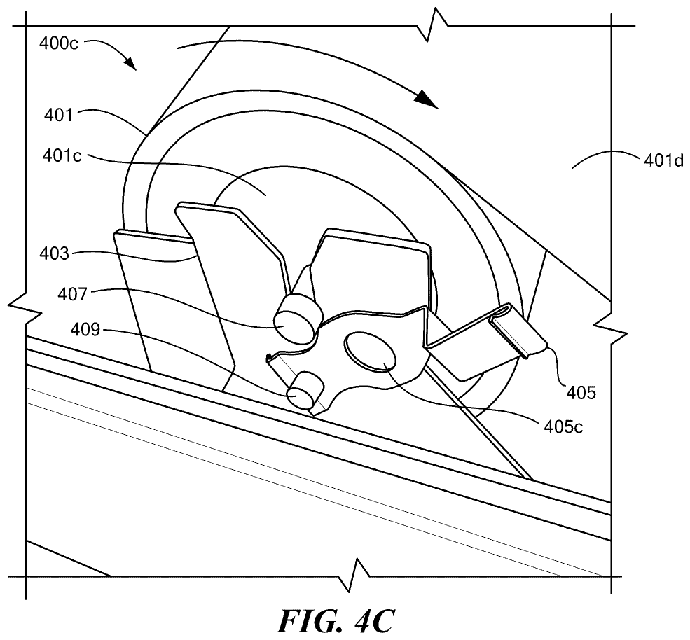

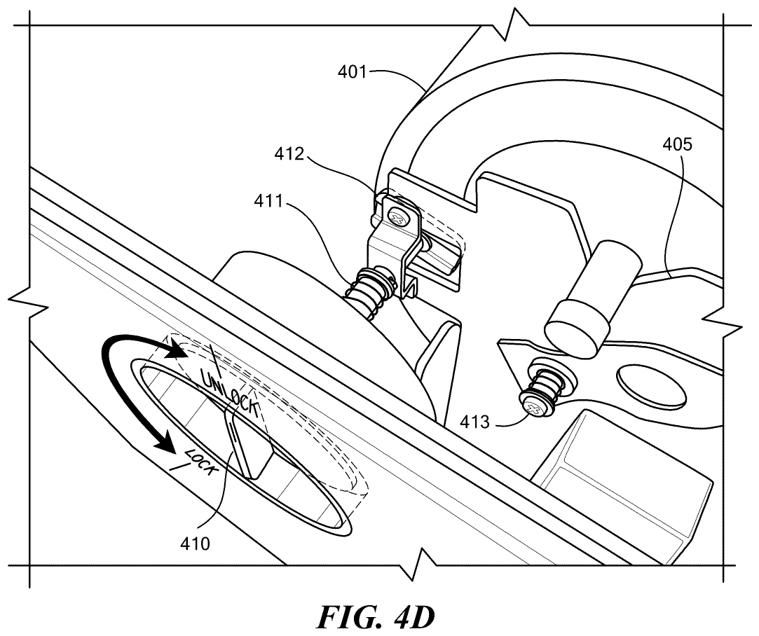

FIGS. 4A and 4B are alternative views of a paper axle hold down lock design, in accordance with some embodiments. FIG. 4A shows an engaged state 400a and FIG. 4B shows a disengaged state 400b. Paper roll 401 is mounted on axial roll holder 407b, which fits into a slot in sidewall mounting plate 403 and is free to spin along with the paper roll. Paper roll 401 is further secured as follows by retaining clip 405, which is axially mounted on bolt 409. Bolt 409 is coupled to sidewall mounting plate 403. FIG. 4A shows retaining clip 405 in an engaged position, where the end of retaining clip 405 is bent such that it is configured to hold paper roll 401 in place vertically; as well, when in an engaged position, the central hole of retaining clip 405 also is clipped onto the end of axial roll holder 407b to function as a hold-down. Retaining clip 405 is also called hold-down clip in this disclosure. Retaining clip 405, even in an engaged position, permits rotation of the paper roll and permits ordinary operation of the printer. In FIG. 4B, retaining clip 405 is in an disengaged position, allowing paper roll 401b to be extracted together with axial roll holder 407b. In some embodiments, axial roll holder 407b may be coupled to the paper roll while outside of the printer module prior to reloading; in other embodiments, axial roll holder 407b may be coupled to a sidewall (not shown) on another side of the printer module and paper roll 401 may slide onto it. To exchange or secure a paper roll, the retaining clip 405 is manually moved into or out of the engaged position. Axial roll holder 407b is shown in a top-down view in FIG. 2 as 202 and in FIG. 4C as 407. A brake mechanism, shown in FIG. 4D, also prevents paper roll 401 from moving, as further described below.

FIG. 4C is an additional alternative view of a paper roll axle hold down lock design, in accordance with some embodiments. View 400c is a perspective view of a paper roll axle hold down lock design from above and to the side in an disengaged state but such that paper roll 401 is properly seated. Paper roll 401 is mounted on axial roll holder 407. Paper roll core 401c is also shown together with paper roll 401. A top sheet of paper 401d is shown being fed off of the paper roll and into the printer module. It is desirable for the paper roll to be held down during transport such that the paper roll core 401c and axial roll holder 407 does not separate from the sidewall mounting plate 403. Hole 405c is configured to line up with axial roll holder 407, such that hold-down clip 405 may be secured tightly against sidewall mounting plate 403 when in the engaged position. To exchange or remove a paper roll, a user may manually pull hold-down clip 405 away from and off of axial roll holder 407 to remove the paper roll 401 from its seated position, and may reverse the operation to secure or hold down the paper roll by manually pulling hold-down clip 405 away from the paper roll and seating axial roll holder 407 inside the hole 405c in hold-down clip 405 to hold down the paper roll, in some embodiments. Hold-down clip 405 is able to be repositioned due to its being coupled with spring assembly 413 (shown in FIG. 4D), in some embodiments. Axial roll holder 407 is shown in a top-down view in FIG. 2 as 202. A brake mechanism, shown in FIG. 4D, also prevents paper roll 401 from moving, as further described below.

FIG. 4D is a perspective view of a paper roll brake design, in accordance with some embodiments. While paper roll 401c is held down by hold-down clip 405 as shown in FIG. 4C, it is additionally desirable for the paper roll to be held in place and prevented from rotating during transport such that additional paper does not feed off of the paper roll and therefore so that top sheet 401d does not crinkle, although the paper roll brake should be disengaged when printing is actively being performed. Paper roll 401 is held in place and prevented from rotating using a brake mechanism, described as follows. Brake pad 410 is enabled to make contact with paper roll 401 by brake pad spring screw 411 (which is held in place by fixed brake pad bracket 412), causing it to make contact with the paper roll and prevent it from rotating. Knob 420 is manually operable from an exterior of the printer module, such that when in an unlocked position knob 420 disengages the brake pad and allows unimpeded motion of the paper roll, e.g., for normal paper feeding during printing, and when in a locked position, knob 420, together with brake pad spring screw 411, engages the brake pad such that it is pressed against the paper roll. FIG. 4D shows the brake pad 410 and hold-down clip 405 each in an unlocked or disengaged position.

In some embodiments, a printer supports standard page description languages, which may include any of the following: HTML, XML, PostScript, PDF, LaTeX, Microsoft Word, plain text, or any other electronic form of page description. In some embodiments, the printer may receive a ballot specified in a file or a bit stream in a standard page description language, which may be referred to as a ballot printer description file, and wherein the specification for the document includes pages, and wherein the pages are formatted using a ballot marking or printing application. The ballot marking application may accept input from a user (e.g., a voter) to indicate his or her selections from the set of possible vote selections defined for a particular election, which is a logical representation of a ballot. The output of the ballot marking application may use the voter input combined with the logical ballot and information about the ballot layout to generate a page image, and may send the page image to the printer in a page description language as identified herein, in some embodiments. In some embodiments, the ballot printing application may be operated by an election administrator or poll worker, to generate and print one or more blank paper ballots using the printer.

Ballot marking and printing software, page generation software, print preview, and touchscreen input may be features present on the CPU that are enabled via the touchscreen and other user input devices.

In some embodiments, features that support full-face ballot printing are supported. Timing marks may be inserted by the image generation software into the print image before printing. A cutter is provided in conjunction with a roll paper feed mechanism that cuts the paper at an appropriate size, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

A paper stock that is suitable for dual-sided direct thermal printing, in some embodiments, is further described below.

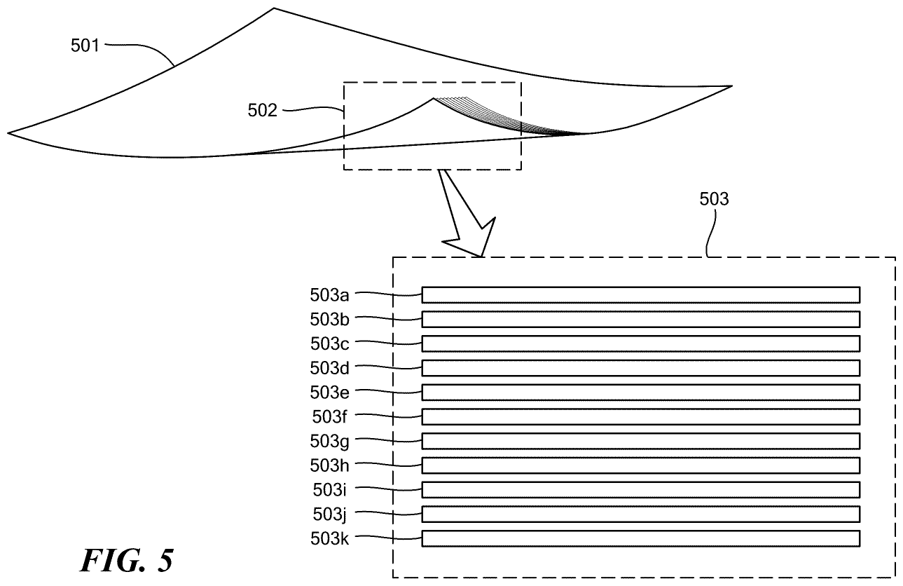

FIG. 5 is a cross-sectional cutaway view of a portion of a suitable printing medium, in accordance with some embodiments. Sheet 501 has been cut from a roll of paper. Inset region 502 is shown in magnified view 503. The paper may be based on a cellulosic fiber core or substrate, combined with thermal printing coatings on the front and back side (first and second side).

The layers of the paper, in one embodiment, are as follows: top coating 503a; thermal color change chemistry 503b; primer 503c; base paper 503d; protective back coating 503e; adhesive 503f; protective back coating 503g; base paper 503h; primer 503i; thermal color change chemistry 503j; and top coating 503k. The protective back coatings enable the paper to be adhered together, and may be formulated to reduce bleed-through or migration of adhesive through the core of the paper to the front or back, in some embodiments. The top coatings may enable smudge, scratch and friction resistance, suitable for repeated handling and long-term storage, and may enable water-resistance, in some embodiments. A variety of materials can be used for the heat change material/thermal color change chemistry, such as a lueco dye, or a lueco dye as combined with appropriate co-reactant chemicals and sensitizers, such as those disclosed in U.S. Pat. No. 5,883,043 issued Mar. 16, 1999, hereby incorporated by reference. The base paper may be formed in the form of a nonwoven web of natural cellulosic, wood pulp, or other fibrous material by air-forming, wet-forming, or another paper making process. In some embodiments, paper characteristics and coating characteristics may be selected for enhancing hand-marking (including ballot hand-marking), smoothness, absorption, opacity, or brightness characteristics, without compromising imaging and archivability, specifically such as the use of calcium carbonate or kaolin clay. In some embodiments, the brightness may be above 70 and below 90 on a standard scale of paper brightness; in some embodiments the brightness may be approximately 85. In some embodiments, the coatings and primers are formulated to be free of bisphenol-A (BPA) and/or bisphenol-S (BPS). In some embodiments, the adhesive may be a vinyl acetate emulsion or permanent acrylic emulsion. In some embodiments the adhesive may have a low minimum application temperature) (35°, and a high service temperature range (from −50° to 200° F.). In some embodiments, the top coatings may be suitable for enabling hand-markability; the top coatings may be coatings that are generally available for purchase in the industry.

The two base papers may be separately covered with the other coatings and mixtures, and then adhered back-to-back, in some embodiments. In alternate embodiments, a single base paper may be used with coatings 503a, 503b, 503c applied to a first side of the single base paper and coatings 503i, 503j, and 503k applied to a second side of the single base paper. The layers of the paper may be applied using any suitable means, such as flooding and metering and subsequently drying, spraying, or dipping etc. Generally, coatings on the paper, and specifically the adhesive, are less than 0.0001 inches thick, in some embodiments. The paper may be 7 mils thick, in some embodiments. Dynamic and static sensitivity of the paper may be designed such that the thermal printing process has high print quality (e.g., high contrast and dark black levels), moderate electricity usage (e.g., using as low a temperature as needed), and good color change speed that is suitable for the elections use case (e.g., approximately the speed required for a double-sided full page print on a laser printer). Specifically, in a preferred embodiment, a dynamic sensitivity of ≥1.8 ODU at 14 mJ/mm², and a brightness grade of ≥77 is provided, with the greatest thermal paper sensitivity during printing (dynamic sensitivity) being within the range of 11-14 mJ/mm², and with a corresponding optical density change between at least 0.1 and 1.1 (fully developed). In some embodiments, the thermal imaging layer may be grayscale and may enable 9 levels of grayscale, or more.

In some embodiments, security features may be provided in or on the paper to enhance election security, such as special black light, ultraviolet (UV), or infrared (IR) ink, thermochromic inks, holographic seals, watermarks, or preprinted barcodes. These security features may be provided at the time of production of the paper, and may involve additional printing steps for each security feature. In some embodiments, the paper may come with indicia of its chain of custody, also for enhancing election security, chain of custody, and inventory management. In some embodiments, the security features are sprayed on at time of manufacture through a stencil while the paper is unrolled and/or in the process of re-rolling.

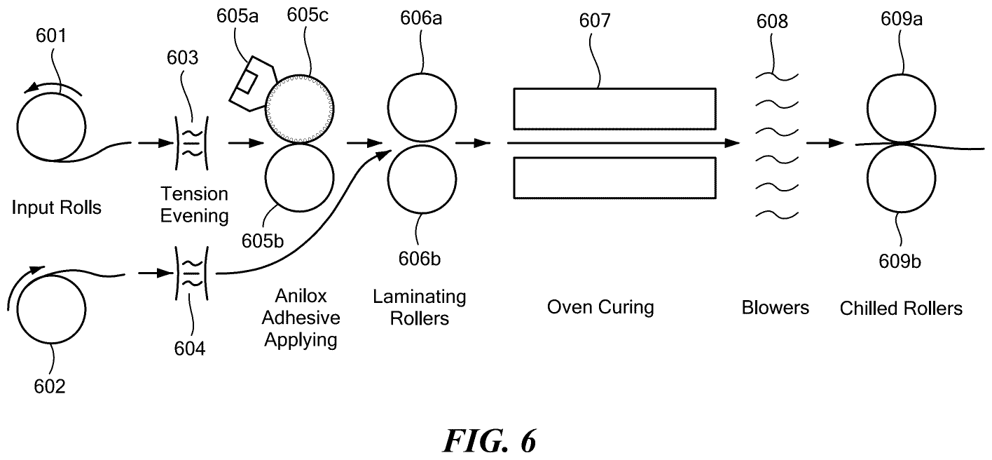

FIG. 6 is a schematic diagram of a method of manufacture for a double-sided thermal ballot stock, in accordance with some embodiments. Input rolls 601 and 602 are rolls of base paper which have been previously formed with thermal imaging layers; each input roll has a thermo-sensitive ink layer disposed on the side of the paper oriented towards the outside of the roll. Input roll 601 is unspooled onto festooning rollers 603, and input roll 602 is unspooled onto festooning rollers 604. The moving paper is called a web, as commonly understood in the art; the web resulting from input roll 601 is called input web 601 and the web resulting from input roll 602 is called input web 602, where appropriate below. Both of 603 and 604 are configured to even out tension on the paper and thus to increase, as much as possible, the flatness of the paper before it enters into the adhesive adhering step. The tension of the paper may be adjustable at the festooning rollers to enable an operator to produce an appropriately flat paper without undesirable curl, in some embodiments. Curl and tension may also be adjusted by adjusting the speed of the unspooling of input roll 601 and/or input roll 602, and the speed of each resultant moving web, in some embodiments. Adjustment is performed independently of each roll, in some embodiments.

Input web 601 is spooled onto adhesive adhering rollers 605a, 605b, which have adhesive applied to one or both of them, to cause the input web 601 to receive adhesive. In some embodiments, adhesive adhering roller 605a is an anilox roller and the adhesive is heated and applied to it in liquid form, to be rapidly cooled and set once applied. In some embodiments, the anilox rollers may be conical or may be cylindrical. The anilox roller has indentations in its surface that receive adhesive from an adhesive reservoir 605c and then apply it to the paper in a controlled fashion. The anilox rollers are fed adhesive from an adhesive reservoir or adhesive chamber. Adhesive is scraped off the anilox roller by a doctor blade to avoid overapplication of adhesive to the roller. Although spraying directly onto the paper is a common approach used for a single-layer coating, since the adhesive needs to be applied not only to the top of one web but also to the underside of another web, spraying becomes significantly difficult due to gravity and an anilox roller is preferred. In some embodiments, the adhesive may be an acrylic adhesive and may be liquid at ambient temperature. In some embodiments, the adhesive is applied using the anilox rollers without adhesive coverage to the edge of the web, thereby leaving a gap into which glue can be flattened.

Rollers 606a, 606b are laminating rollers, which may be configured in a pair; both input web 601 with the adhesive, and input web 602, are fed through the laminating rollers to cause the paper to be adhered or laminated, back to back, onto each other to produce a single web of paper. The laminating rollers physically press down on the glue to make sure the adhesive is smooth and edge to edge. The orientation of input web 602 is flipped such that, in some embodiments, the thermal imaging layer of input web 601 is oriented upward and the thermal imaging layer of input web 602 is oriented downward, with the adhesive being disposed between the two input webs, in some embodiments. In some embodiments, the two input webs are adhered together in an orientation that reduces curl caused by the natural memory of each input roll of paper being wound around its own core; this is shown in FIG. 6 by indicating that input roll is unspooled clockwise while input roll 602 is unspooled counterclockwise, but the opposite orientation is also equivalent. In some embodiments, adhesive application may be performed at a web travel speed of 100 meters per minute.

Following adhesive application and lamination, an oven stage 607 is used to cure the adhesive. In some embodiments, the oven stage may be multiple stages with multiple temperatures. In some embodiments, temperature of the oven is adjusted in conjunction with the speed of the web to ensure that the thermal layers of the paper are not activated. In a preferred embodiment, the oven is set at 152 degrees. Following the oven, a blower stage 608 is used to rapidly reduce the temperature of the cured adhesive, in some embodiments, which may be ambient temperature or may be chilled air. Following the blower stage, the web is chilled to set the adhesive using chilled rollers 609a, 609b, in some embodiments. The chilled rollers may be made of chrome or brass for its flatness and thermal characteristics, in some embodiments. The chilled rollers are chilled using tap water, in some embodiments.

Subsequently, various possible steps may be performed, such as curl evaluation, spooling onto a core of a certain size, cutting into smaller rolls or sheets. In some embodiments, the final paper may be provided in rolls sized for industrial printing use, or in rolls sized for use with an on-site ballot printer as described above, or in sheets. In some embodiments, the length of an individual roll is configured with election applications in mind. For example, with a 13-hour voting day in mind, with individual voters voting every 5 minutes, a roll of 8″ outer diameter and 500′ length is sufficient for a single voting machine to conduct electronic ballot marking with an electronic ballot marking device without reloading ballot media. The inventors have contemplated other lengths that are suitable for different intensities of voting or for other voting applications such as on-demand ballot printing. Additionally, in some embodiments, a standard ballot size is considered for the size of the paper. For a standard U.S. ballot size, 8.5″ width is suitable; the use of a continuous roll allows various standard U.S. ballot lengths, such as ballots between 11″ and 30″ in length, without being limited to a specific size ballot sheet. Ballot printing also requires paper to lie relatively flat, within the ordinary meaning of the term “flat.”

The steps of FIG. 6 may be performed in a different order, in various embodiments. Input roll 602 may be spooled onto the adhesive adhering rollers instead of input roll 601; both of input rolls 601 and 602 may be spooled onto the adhesive adhering rollers; in some embodiments, adhesive is caused to be sprayed on instead of using adhesive adhering rollers. In some embodiments, the laminating roller, or any of the one or more of the various sets of rollers, may be chilled to set the adhesive and/or to further reduce the temperature of the paper, thereby making activation of the thermo-sensitive ink less likely. In some embodiments, one or more of the input rolls may be pre-cooled to further reduce the temperature of the paper. In some embodiments, the paper may be acclimated to a relatively cool ambient temperature and humidity prior to being processed, without active cooling.

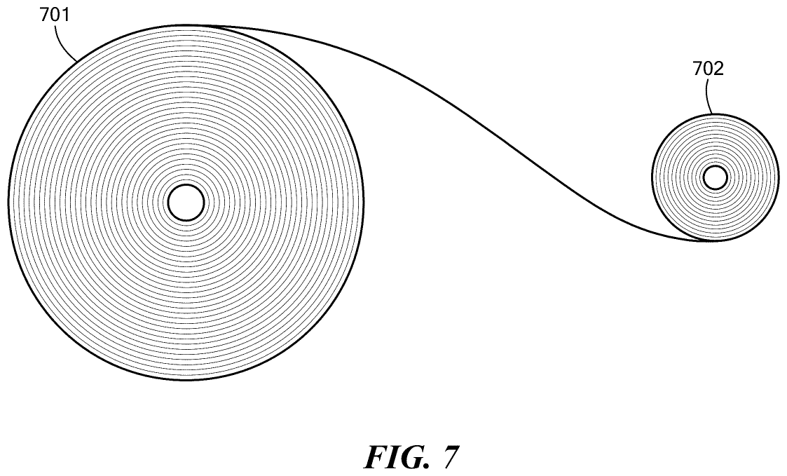

FIG. 7 shows unspooling and respooling of a completed double-sided roll 701 onto another roll 702, in some embodiments. Unspooling and respooling is performed in such a way as to reverse the direction of curl of the paper, which produces improved curl properties in the final paper. Watermarks, security features such as black light watermarks, bar codes, serial numbers, and/or branding may be applied at this stage before cutting. In some embodiments, a larger or smaller core can be used for the respooled roll. In some embodiments the individual cores may be cores with a 3″ inner diameter and a 4″ outer diameter to reduce undesirable curl and wastage, as well as to provide purchase for a paper roll brake. In some embodiments, the respooled roll is spooled to a desired diameter and cut into smaller segments to produce final output paper. In some embodiments, the respooled roll is cut into smaller rolls of 8½ inches width for use in printing 8½ inch ballots. Other forms of paper are also contemplated, such as a fan-folded and perforated format for being fed into a ballot printer.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method of manufacturing double-sided thermal ballot stock, comprising:
receiving an input roll of paper having a thermo-sensitive ink layer and a base paper layer and emitting a first web;
tension evening of the first web using festooning rollers;
receiving a second input roll of paper having the thermo-sensitive ink layer and the base paper layer and emitting a second web;
tension evening of the second web using the festooning rollers;
applying an adhesive in a liquid state using anilox rollers to the base paper layer of the first web;
laminating the first web and the second web through laminating rollers, with the base paper layer of the first web contacting the base paper layer of the second web using the adhesive to create a laminated output web;
heating the laminated output web to cure the adhesive in an oven while moving the laminated output web through the oven; and
reducing a temperature of the applied liquid adhesive in the laminated output web using an air cooling station.

2. The method of claim 1, further comprising reducing a temperature of the laminated output web using chilled rollers.

3. The method of claim 1, wherein the base paper layer comprises wood pulp and the adhesive is acrylic.

4. The method of claim 1, wherein the temperature of the liquid adhesive is below 100° Fahrenheit at the time of application.

5. The method of claim 1, wherein the anilox rollers are cooled to promote adhesion between the two base paper layers while preventing activation of the thermo-sensitive ink layer of the first web and the thermo-sensitive ink layer of the second web.

6. The method of claim 1, wherein one or more of the festooning rollers, the anilox rollers, the tensioning rollers, and the finishing rollers are chrome rollers.

7. The method of claim 1, further comprising re-spooling an individual paper roll of the output web onto an additional roll core.

8. The method of claim 1, further comprising producing a roll core having an outer diameter greater than or equal to 4 inches, such that paper disposed on an inner diameter of the roll core is conducive to printing flat output media.

9. The method of claim 1, further comprising producing a roll core having a core wall with a thickness greater than or equal to 0.5 inches to facilitate a printer paper brake.

10. The method of claim 1, further comprising cutting consumable rolls to a length of at least 400 feet and less than 525 feet.

11. The method of claim 1, further comprising unspooling the output web from a larger roll and re-spooling the output web in the opposite direction to a smaller roll core to counteract a paper memory effect curl.

12. The method of claim 1, further comprising applying one or more of ultraviolet (UV) black light ink, infrared (IR) ink, thermochromic ink, holographic seals, watermarks, and preprinted barcodes for election security.

13. The method of claim 1, further comprising applying a top coat for hand-markability.

14. A double-sided thermally-printable paper, comprising:
a first top coating layer having an outer side and an inner side;
a first thermal color change chemistry layer having an outer side and an inner side, the outer side bound to the inner side of the first coating layer;
a first primer layer having an outer side and an inner side, the outer side bound to the inner side of the first thermal color change chemistry layer;
a first base paper layer having an outer side and an inner side, the outer side bound to the inner side of the first primer layer;
an interpositional adhesive layer having a first side and a second side, the first side bound to the inner side of the first base paper layer;
a second base paper layer having an inner side and an outer side, the inner side bound to the second side of the interpositional adhesive layer;
a second primer layer having an inner side and an outer side, the inner side bound to the outer side of the second base paper layer;
a second thermal color change chemistry layer having an inner side and an outer side, the inner side bound to the outer side of the second primer layer; and
a second top coating layer having an outer side and an inner side, the inner side bound to the outer side of the second thermal color change chemistry layer,
wherein the first thermal color change chemistry layer and the second thermal color change chemistry layer are thereby disposed to be printed on from either side of the double-sided thermally-printed paper.

15. The paper of claim 13, the inner side of the first base paper layer further comprising a first protective back coating layer and the inner side of the second base paper layer further comprising a second protective back coating layer, the first and the second protective back coating layer for preventing migration of adhesive from the interpositional adhesive layer.

16. The paper of claim 13, wherein the first thermal color change chemistry layer and the second thermal color change chemistry layer have a thermal response with an optical density greater than 1.10 optical density units (ODU).

17. The paper of claim 13, wherein the first thermal color change chemistry layer and the second thermal color change chemistry layer have a thermal response with a dynamic sensitivity of at least 1.8 ODU at 14 mJ/mm².

18. The paper of claim 13, wherein the interpositional adhesive layer is cooled during manufacture to reduce the likelihood of thermal color change of the first thermal color change chemistry layer and the second thermal color change chemistry layer.

19. The paper of claim 13, wherein the interpositional adhesive layer is cooled using an air cooling station during manufacture.

20. The paper of claim 13, wherein the interpositional adhesive layer is cooled using a plurality of chilled rollers during manufacture.

21. The paper of claim 13, wherein the first thermal color change chemistry layer and the second thermal color change chemistry layer each use a lueco dye thermal color change chemistry.

22. The paper of claim 13, further comprising a roll core, and wherein the double-sided thermally-printable paper is rolled around the roll core.

23. The paper of claim 13, wherein an inner diameter of the roll core is 3 inches and an outer diameter of the roll core is 4 inches.

24. The paper of claim 13, wherein the paper has a width of 8½ inches.

25. The paper of claim 13, wherein the first top coating layer and the second top coating layer are formulated to be free of bisphenol-A (BPA).

26. The paper of claim 13, wherein the paper has a lay flat curl characteristic when cut to standard United States legal size.

27. The paper of claim 13, further comprising one or more of ultraviolet (UV) black light ink, infrared (IR) ink, thermochromic ink, holographic seals, watermarks, and preprinted barcodes for election security.

28. The paper of claim 13, further comprising a top coat for hand-markability.

29. The paper of claim 13, wherein the paper is used for election ballots.
